(19) United States
(12) Patent Application Publication
(10) Pub. No.: US 2015/0207452 A1
(43) Pub. Date: Jul. 23, 2015

(54) SINGLE AXIS SOLAR TRACKER

(71) Applicant: MAGNA INTERNATIONAL INC., Aurora (CA)

(72) Inventors: Mark Francis Werner, LaSalle (CA); Matthias Peter Woletz, Clawson, MI (US); Michael Gregory Zuzelski, Beverly Hills, MI (US)

(21) Appl. No.: 14/416,889

(22) PCT Filed: Jul. 23, 2013
(86) PCT No.: PCT/US13/51733

§ 371 Date: Jan. 23, 2015

Related U.S. Application Data
(60) Provisional application No. 61/674,641, filed on Jul. 23, 2012.

(51) Int. Cl. H02S 20/32; F24J 2/38

(52) U.S. Cl. CPC H02S 20/32; F24J 2/38

(57) ABSTRACT

A single axis solar tracker assembly for supporting and controllably rotating a plurality of solar panels is provided. The solar tracker assembly includes a plurality of sub-assemblies which are spaced from one another in a first direction and are operably coupled with a driveshaft that is moveable in the first direction. Each sub-assembly includes at least one torque tube which extends in a second direction and torque arm which is operably coupled with the at least one torque tube. Each sub-assembly further includes a connector which operably connects the torque arm with the driveshaft for rotating the at least one torque tube in response to movement of the driveshaft in the first direction. The connector is pivotably coupled with the torque arm and non-pivotably coupled with the driveshaft and extends in a vertical direction to provide for an increased vertical distance between the torque arm and the driveshaft.

### CROSS REFERENCE TO RELATED APPLICATIONS

This U.S. National Stage Patent Application claims the benefit of PCT International Patent Application Ser. No. PCT/US2013/051733 filed Jul. 23, 2013 entitled “Single Axis Solar Tracker”, which claims the benefit of U.S. Provisional Patent Application Ser. No. 61/674,641 filed Jul. 23, 2012 entitled “Solar Photovoltaic Single Axis Tracker”, the entire disclosures of the applications being considered part of the disclosure of this application, and hereby incorporated by reference.

### BACKGROUND OF THE INVENTION

1. Field of the Invention

The present invention relates generally to support frame assemblies for solar related devices, and more particularly to support frame assemblies which are adjustable to controllably rotate a plurality of solar panels about a single axis.

2. Related Art

Solar trackers are devices which include a plurality of solar panels and (such as, for example, photovoltaic panels, reflectors, lenses or other optical devices) are operable to automatically adjust the orientations of those panels throughout each day to maximize the amount of solar rays captured or reflected by the solar panels. Solar trackers generally have a support frame assembly which engages and supports the solar panels. Typically, each support frame assembly has its own actuator for adjusting orientations of the solar panels.

Other types of solar trackers have a driveshaft which extends between and is operably connected to a plurality of sub-assemblies, each of which has a support frame assembly and a plurality of solar panels. Each sub-assembly includes a torque tube which supports the solar panels and a torque arm which interconnects the torque tube with the driveshaft. In operation, an actuator moves the driveshaft through a generally arcuate path, and this motion is translated through the torque arms into the torque tubes to rotate solar panels. As such, the single actuator simultaneously adjusts the orientations of the solar panels of a plurality of sub-assemblies that are spaced from one another.

There remains a significant and continuing need for a more efficient and less costly solar tracker.

### SUMMARY OF THE INVENTION AND ADVANTAGES

One aspect of the present invention provides for an improved solar tracker assembly for supporting and controllably rotating a plurality of solar panels. The solar tracker assembly includes a plurality of sub-assemblies which are spaced from one another in a first direction and are operably coupled together with a driveshaft that is moveable in the first direction. Each of the sub-assemblies includes at least one torque tube that extends in a second direction which is angled relative to the first direction. Each of the sub-assemblies further includes a torque arm which is operably coupled with at least one torque tube. Additionally, each of the sub-assemblies includes a connector which operably connects the torque arm with the driveshaft for rotating the torque tube in response to movement of the driveshaft in the first direction, and the connector is pivotably coupled with the torque arm and is non-pivotably coupled with the driveshaft. The connector extends in a vertical direction between the torque arm and the driveshaft to provide for an increased vertical distance between the torque arm and the driveshaft.

The improved solar tracker assembly offers a number of advantages as compared to other known solar tracker assemblies. For example, because of the increased vertical distance between the torque arm and the driveshaft, a gap is not required between solar panels immediately above the driveshaft, i.e. the solar panels may extend the entire length of the torque tube. As such, the improved solar tracker assembly may harness more solar rays and produce more electricity than other known solar trackers. This comes without having to increase the length of the torque arm, which would make actuation of the driveshaft more difficult. The various components of the improved solar tracker assembly may also be fabricated at a low cost and may be assembled in the field very quickly and without any special equipment.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of an exemplary solar tracker assembly;

FIG. 2 is an enlarged and perspective view of a support post and a bearing of the exemplary solar tracker assembly of FIG. 1;

FIG. 3 is an enlarged and fragmentary view of one of the support posts and bearings of the exemplary solar tracker assembly of FIG. 1 and taken from a different vantage point than FIG. 2;

FIG. 4 is an enlarged and perspective view of one of the bearings of the exemplary solar tracker assembly of FIG. 1;

FIG. 5a is a perspective view of a subassembly of the exemplary solar tracker assembly of FIG. 1;

FIG. 5b is a fragmentary view of a torque arm of one of the subassemblies interconnected with a driveshaft of the exemplary solar tracker assembly of FIG. 1;

FIG. 6 is a perspective view of a frame assembly of one of the subassemblies of the exemplary solar tracker assembly of FIG. 1 with the associated photovoltaic panels disposed in a zero degree orientation;

FIG. 7 is a fragmentary view of a support post of the exemplary solar tracker assembly of FIG. 1; and

FIG. 8 is a cross-sectional view showing the movement of the photovoltaic panels in response to movement of the driveshaft of the solar tracker assembly of FIG. 1.

### DESCRIPTION OF THE ENABLING EMBODIMENT

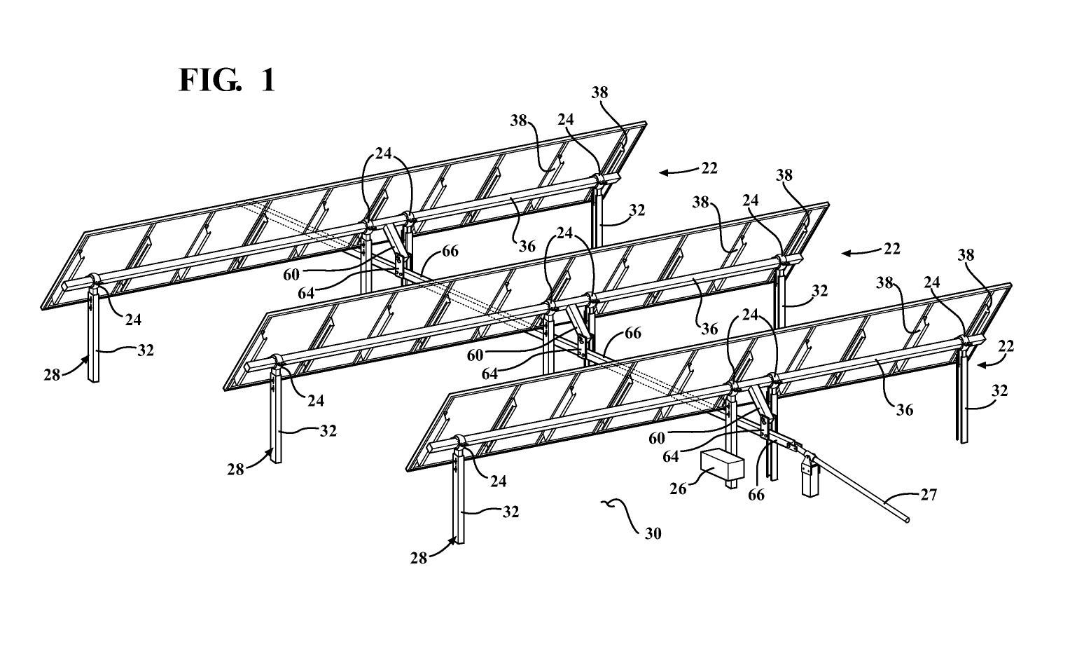

Referring to the Figures, wherein like numerals indicate corresponding parts throughout the several views, an exemplary embodiment of a single axis solar tracker assembly 20 for harnessing potential energy from solar rays and generating electricity is generally shown in FIG. 1. As shown, the solar tracker assembly 20 includes a plurality of sub-assemblies 22 (these being shown in the exemplary embodiment) which are spaced from one another in a longitudinal or first direction. The longitudinal direction could be a north-south direction, an east-west direction or any desirable direction. As shown, each of the exemplary sub-assemblies 22 has its own array of photovoltaic panels 24 which are configured to convert solar radiation into direct current (DC) electricity. The arrays of the different sub-assemblies 22 are all arranged to face in the same general direction, and as will be discussed in further detail below, the sub-assemblies 22 are all mechanically interconnected with one another so that a single driving unit or actuator 27 may simultaneously rotate the photovoltaic panels 24 of all of the sub-assemblies 22. As such, the single actuator 27 is operative to adjust the sub-assemblies 22 such that the photovoltaic panels 24 simultaneously “follow the sun” across the sky during each day to increase the total amount of solar rays harnessed and the total amount of electricity generated by the photovoltaic panels 24 each day as compared to solar assemblies with stationary/non-moveable photovoltaic panels. It should be appreciated that the sub-assemblies 22 could include mirrors or any desirable type of solar panels in place of or in addition to the photovoltaic panels 24 of the exemplary embodiment. Additionally, it should be appreciated that the actuator 27 may be any suitable type of actuator such as, for example, an electric motor, a pneumatic motor or a hydraulic motor.

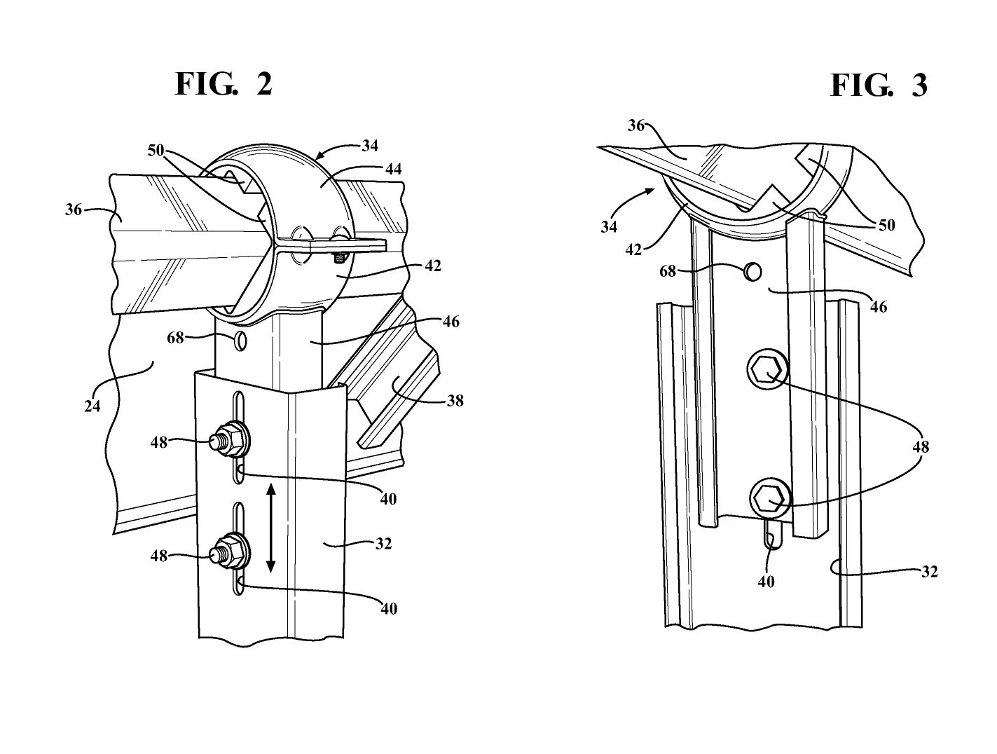

Referring still to FIG. 1, each of the sub-assemblies 22 includes a frame structure 28 which supports the photovoltaic panels 24 above a base 30, such as the ground, a platform or a roof of a building. As discussed in further detail below, each of the frame structures 28 includes a plurality of support posts 32 which extend generally vertically upwardly from the base 30; a plurality of bearings 34 (best shown in FIGS. 2-4) which are positioned at the upper ends of the support posts 32; a torque tube 36 which extends between and is supported by the bearings 34; and a plurality of rails 38 which support the photovoltaic panels 24.

The support posts 32 of each frame structure 28 are anchored to the base 30 and are spaced apart from one another in a lateral (or second) direction, which is perpendicular to the aforementioned longitudinal direction. As shown in FIGS. 2-4 the support posts 32 of the exemplary embodiment have generally C-shaped cross-sections, and each support post 32 has a pair of spaced apart and vertically extending slots 40 adjacent their upper ends. It should be appreciated that the support posts 32 may have any suitable shape. The support posts 32 are preferably made of a metal, such as steel or aluminum, but may be of any suitable material and may be shaped through any suitable process or combination of processes including, for example, roll forming, extrusion, stamping, machining, etc.

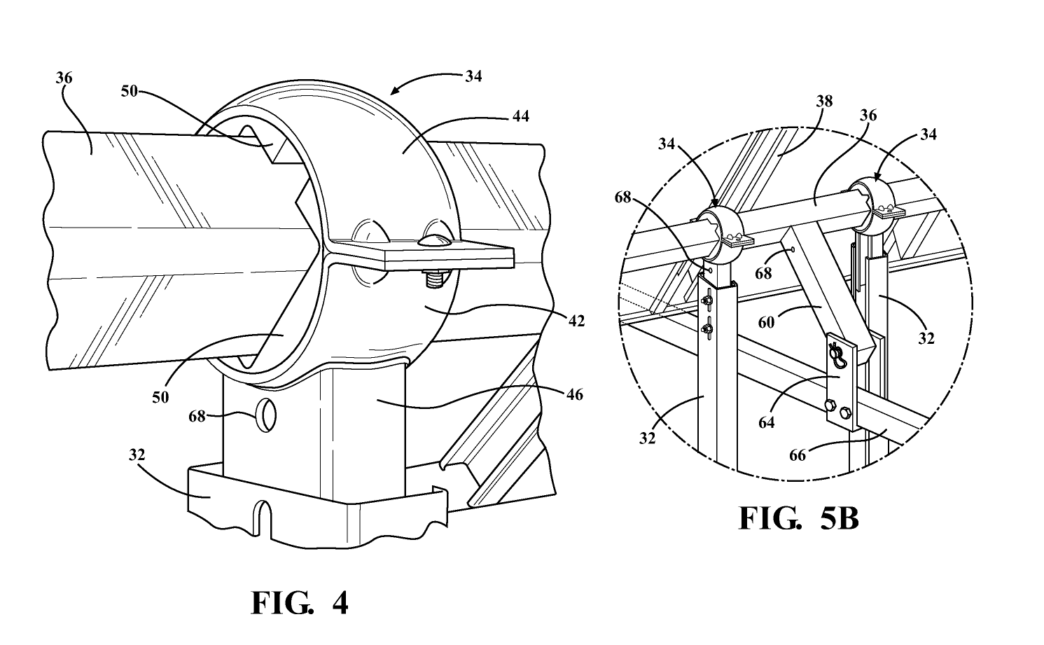

Referring now to FIG. 4, each of the bearings 34 includes lower (or first) and upper (or second) shells 42, 44, each of which has a semi-spherical outer surface and a semi-spherical inner surface (not shown). In the exemplary embodiment, the lower and upper shells 44, 42 are of identical shape and construction, which provides for manufacturing advantages through economies of scale. Each of the lower shells 42 is connected (for example, through welding) to the top of a bearing post 46 which has a pair of apertures that are spaced vertically from one another. The apertures are for connecting the bearing posts 46 with the aforementioned support posts 32 via fasteners 48, e.g. bolts. The lower shells 42 may be attached to the bearing posts 46 in a factory setting before the various components are transferred to the field. The bearings 34 are interconnected with the support posts 32 by aligning the apertures of the bearing posts 46 with the slots 40 in the support posts 32 and inserting the fasteners 48 through the aligned apertures and slots 40. This type of connection is particularly advantageous because it may be established in the field in a very quick manner and without any special equipment. Additionally, the slots 40 in the support posts 32 allow for the heights of the bearings 34 relative to the base 30 (shown in FIG. 1) to be established in the field and to be easily adjusted if needed. For bases 30 having uneven terrain, this may be particularly advantageous. It should be appreciated that the bearing posts 46 may alternately be attached to the support posts 32 through a range of different connection means.

Each of the bearings 34 further includes a pair of races 50 which are configured to surround a portion of the torque tube 36. The races 50 have generally smooth, continuous, and semi-spherical outer surfaces to provide for low-friction contact surfaces between the races 50 and the semi-spherical inner surfaces of the lower and upper shells 42, 44. The races 50 are preferably made of a self-lubricating and low-friction material, such as an acetyl co-polymer. In contrast to cylindrical bearings, which are found in many known solar tracker assemblies, the spherical bearings 34 of the exemplary embodiment compensate for some degree in the rotational variations of the support posts 32 and also may reduce stress at the bearings 34 from wind loading by providing for additional compliance in the joint due to the additional degrees of freedom allowed by the spherical design.

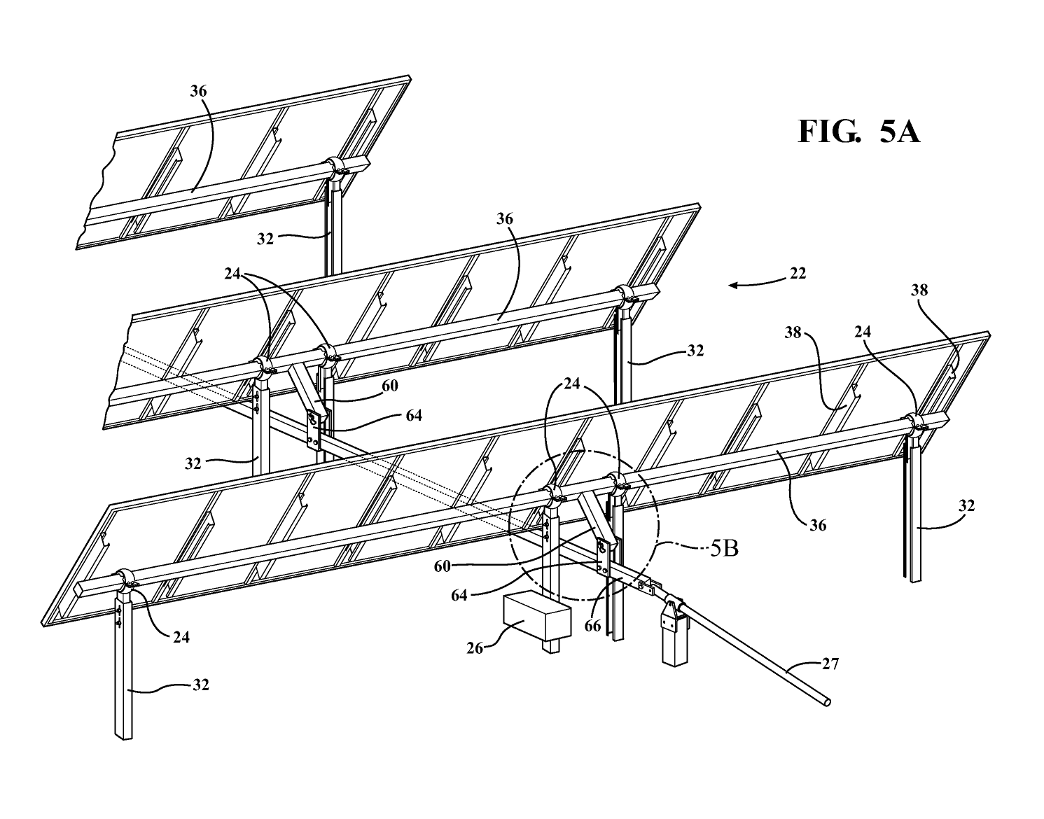

As best shown in FIG. 4, in the exemplary embodiment, the torque tubes 36 are generally rectangularly shaped. However, it should be appreciated that the torque tubes 36 could have any suitable shape such as, for example, a circle. Referring now to FIG. 5a, the rails 38 of the frame structures 28 are spaced in a lateral direction from one another and are interconnected with the torque tubes 36 at approximately their longitudinal mid-points. The photovoltaic panels 24 may be mounted on the rails 38 either in a landscape orientation or a portrait orientation (as shown in the exemplary embodiment). In the exemplary embodiment, each rail 38 is disposed between a pair of photovoltaic panels 24 and supports the adjacent lateral edges of those panels 24.

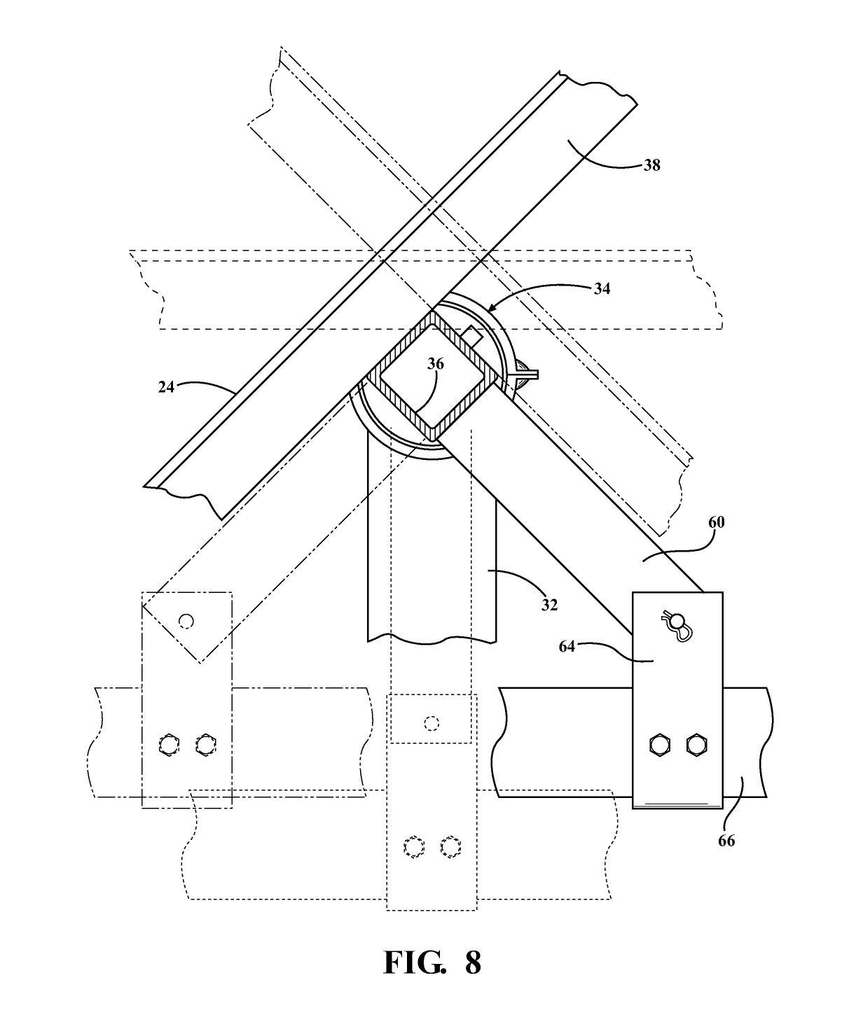

Referring still to FIG. 5a, each of the sub-assemblies 22 additionally includes a torque arm 60 which extends generally perpendicularly away from the torque tube 36 at an approximate lateral midpoint thereof. One end of each torque arm 60 is attached to the associated torque tube 36 through, for example, welding, adhesives, brazing, fasteners, etc. The other end of each torque arm 60 is attached via a connector 64 (such as, for example, one or more brackets) to an elongated driveshaft 66 which extends in the longitudinal direction between all of the sub-assemblies 22 (see FIG. 1). As best shown in FIG. 5b, the connector 64 of the exemplary embodiment is a generally U-shaped bracket 64. The connector 64 is preferably attached to the torque arm 36 with a cleavis pin/cotter pin connection to establish a pivoting connection therebetween and is attached to the driveshaft 66 through a pair of fasteners that are spaced longitudinally from one another to establish a non-pivoting connection therebetween. The dispositions of the connectors 64 between the torque arms 60 and the driveshaft 66 is advantageous because it provides for a vertical offset between the bottoms of the torque arms 60 and the driveshaft 66. This offset ensures a clearance between the lower edges of the photovoltaic panels 24 aligned laterally with and spaced vertically above the torque arm 60 and the driveshaft 66 during rotation of the photovoltaic panels 24. As shown in FIG. 8, this also has the effect of reducing the amount of vertical movement of the driveshaft 66 when rotating the photovoltaic panels 24, i.e. the radius of the arcuate path that the driveshaft 66 must move through to rotate the torque tube 36 and the photovoltaic panels 24 is reduced. Additionally, a “gap” is not required between photovoltaic panels 24 directly above the driveshaft 66 as is included in other known solar tracking systems. In other words, the exemplary sub-assemblies 22 include a constant row of photovoltaic panels 24 with increased electricity generation and improved aerodynamics, which results in a reduced wind turbulence on the sub-assemblies 22. The additional photovoltaic panels 24 may be used, for example, to power battery backups or additional electrical equipment for the system.

As discussed above and shown in FIG. 1, the driveshaft 66 extends longitudinally between and interconnects all of the sub-assemblies 22. The driveshaft 66 is attached to an actuator 27 (such as an electric, hydraulic, or pneumatic motor) which is controlled by a control box 26 for controlling the movement of the driveshaft 66 through an arcuate path which extends in the longitudinal direction. Movement of the driveshaft 66 in the longitudinal direction causes the torque arms 60 to pivot about the torque tubes 36, thereby rotating all of the torque tubes 36 of all of the sub-assemblies 22 simultaneously. This re-orients all of the photovoltaic panels 24 relative to the base 30. As such, a single actuator 27 is able to simultaneously re-orient the photovoltaic panels 24 of all of the sub-assemblies 22, thus allowing the photovoltaic panels 24 to “follow the sun” through the sky to maximize the amount of solar rays harnessed by the solar tracker assembly 20 during each day. Although the exemplary solar tracker assembly 20 includes three sub-assemblies 22, it should be appreciated that any desirable number of sub-assemblies 22 may be attached to one another through the driveshaft 66.

As shown in FIGS. 1 and 5a, the torque arm 60 of each sub-assembly 22 extends generally perpendicularly relative to the photovoltaic panels 24. During heavy winds, this orientation of the torque arm 60 allows it to provide support to the frame structure 28 for resisting wind forces acting on the photovoltaic panels 24.

An exemplary process for assembling the sub-assemblies 22 of the exemplary embodiment in the field begins with anchoring the support posts 32 to the base 30 such that the support posts 32 extend generally vertically upwardly from the base 30. Next, the bearing posts 46, which are attached to the lower shells 42, are joined to the support posts 32 with fasteners, such as bolts. Then, the races 50 are placed around the torque tubes 36 and set into the upwardly facing spherical inner surfaces of the lower shells 42. To secure the torque tubes 36 with the bearings 34, the flanges 58 on the upper shells 44 of the bearings 34 are then secured to the flanges 58 on the lower shells 42. With this, the torque tubes 36 are supported above the support posts 32 by the bearings 34, and the low friction contact between the races 50 and the shells 42, 44 allows the torque tube 36 to rotate relative to the base 30. The rails 38 may then be secured to the torque tubes 36 through any suitable types of connections including, for example, brackets and fasteners. Next, with the rails 38 in place, the photovoltaic panels 24 may be installed onto the rails 38 thereby allowing the photovoltaic panels 24 to rotate relative to the base 30.

Then, the driveshaft 66 may be attached to the sub-assemblies 22 by attaching the connectors 46 to the driveshaft 66 and to the ends of the torque arms 60 through, for example, fasteners. The actuator 27 may then be operably coupled with the driveshaft 66 to move the driveshaft in the longitudinal direction to simultaneously adjust the photovoltaic panels 24 of all of the sub-assemblies 22.

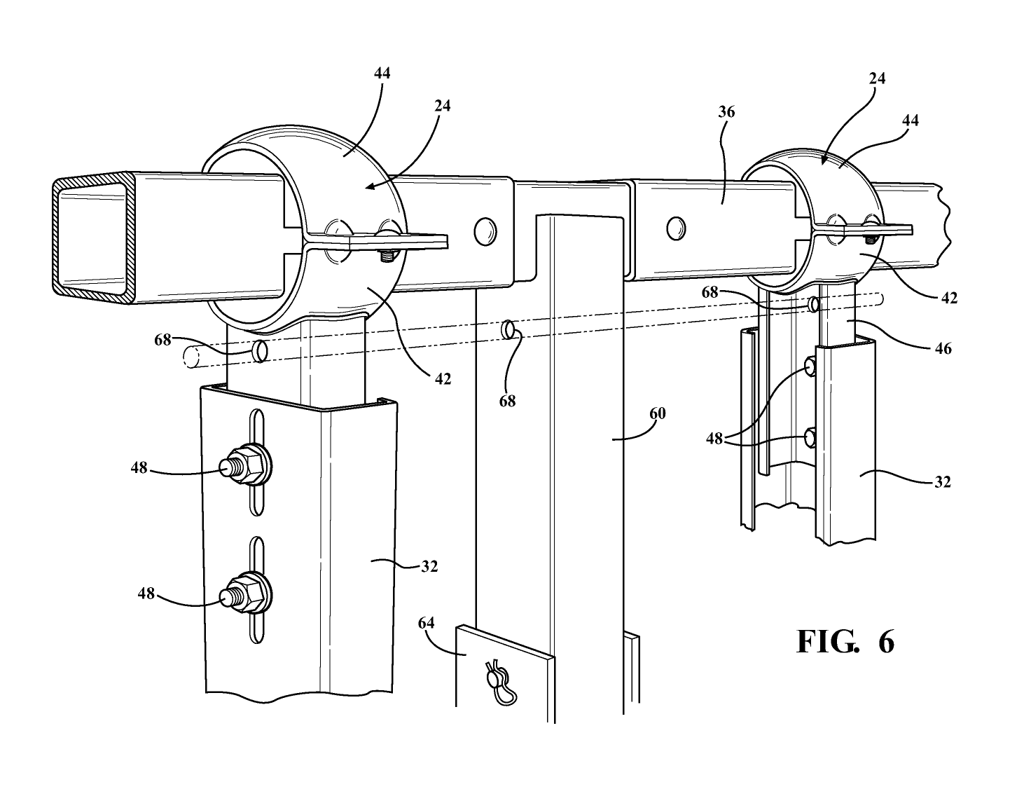

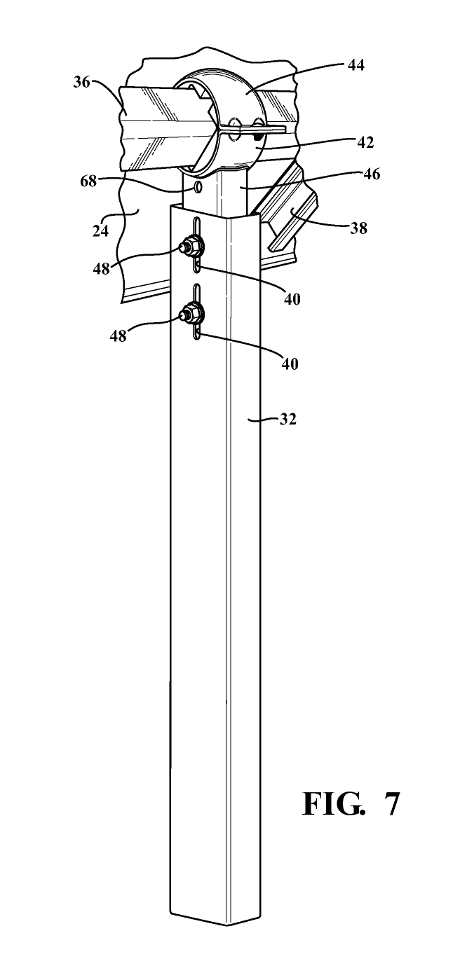

Referring now to FIG. 6, the torque arm 60 and the bearing posts 46 which are adjacent the torque arm 60 all include holes 68 which are aligned with one another when the photovoltaic panels 24 of the corresponding sub-assembly 22 are in a zero degree position, i.e. parallel to the ground. A rod or bolt may then be inserted through these aligned holes to hold the sub-assembly 22 in this position. This may be advantageous during assembly and maintenance of the sub-assemblies 22.

Obviously, many modifications and variations of the present invention are possible in light of the above teachings and may be practiced otherwise than as specifically described while within the scope of the appended claims.

1. A single axis solar tracker assembly for supporting and controllably rotating a plurality of solar panels, comprising:
a plurality of sub-assemblies spaced from one another in a first direction and operably coupled with a driveshaft that is moveable in said first direction, each of said sub-assemblies including:
at least one torque tube extending in a second direction which is angled relative to said first direction,
a torque arm operably coupled with said at least one torque tube,
a connector operably connecting said torque arm with said driveshaft for rotating said at least one torque tube in response to movement of said driveshaft in said first direction, and
said connector being pivotably coupled with said torque arm and non-pivotably coupled with said driveshaft and extending in a vertical direction between said torque arm and said driveshaft to provide for an increased vertical distance between said torque arm and said driveshaft.

2. The solar tracker assembly as set forth in claim 1 wherein said connector of each sub-assembly extends in a vertical direction between said torque arm and said driveshaft.

3. The solar tracker assembly as set forth in claim 1 wherein said connector of each sub-assembly is a bracket.

4. The solar tracker assembly as set forth in claim 3 wherein said bracket of each sub-assembly is generally U-shaped.

5. The solar tracker assembly as set forth in claim 4 wherein a clevis pin is used to establish said pivoting connection between said bracket and said torque arm.

6. The solar tracker assembly as set forth in claim 1 wherein each sub-assembly further includes a plurality of solar collectors operably coupled with said torque tube for harnessing potential energy from solar rays.

7. The solar tracker assembly as set forth in claim 6 wherein said plurality of solar collectors on each sub-assembly are photovoltaic panels.

8. The solar tracker assembly as set forth in claim 7 wherein said photovoltaic panels are coupled with said torque tube via a plurality of rails which are spaced from one another and extend in generally parallel relationship with one another.

9. The solar tracker assembly as set forth in claim 6 wherein said plurality of solar collectors on each sub-assembly includes at least one solar collector aligned in said second direction and spaced vertically above said torque arm.

10. The solar tracker assembly as set forth in claim 1 wherein said second direction is generally perpendicular to said first direction.

11. The solar tracker assembly as set forth in claim 1 wherein each of said sub-assemblies includes a plurality of support posts spaced in said second direction from one another and each having a bearing at its upper end which pivotably supports said torque tube.

12. The solar tracker assembly as set forth in claim 11 wherein each of said bearings has a first shell and a second shell and a pair of races which are rotatable within the confines of said first and second shells.

13. The solar tracker assembly as set forth in claim 11 wherein each of said support posts includes a pair of vertically extending slots and wherein said bearings are attached to said support posts with fasteners which extend through said slots.

14. The solar tracker assembly as set forth in claim 1 wherein said torque arm of each sub-assembly extends generally perpendicularly to said torque tube.

15. The solar tracker assembly as set forth in claim 1 wherein each of said torque tubes is generally rectangular in shape.
